(19) United States
(12) Patent Application Publication
(10) Pub. No.: US 2022/0184697 A1
(43) Pub. Date: Jun. 16, 2022

(54) COMPONENT, APPARATUS, AND METHOD OF MANUFACTURING COMPONENT

(71) Applicant: CANON KABUSHIKI KAISHA, Tokyo (JP)

(72) Inventor: Kenji Matsuda, Kanagawa (JP)

(21) Appl. No.: 17/540,467

(22) Filed: Dec. 2, 2021

(30) Foreign Application Priority Data
Dec. 16, 2020 (JP) 2020-208127

(51) Int. Cl. B22F 7/06; B33Y 70/00

(52) U.S. Cl. CPC B22F 7/06; B33Y 80/00; B33Y 70/00

(57) ABSTRACT

A component includes a magnesium alloy portion and an aluminum alloy portion. The magnesium alloy portion and the aluminum alloy portion are joined with each other via a joining portion. The aluminum alloy portion, the joining portion, and the magnesium alloy portion are covered with a chromium compound film.

### BACKGROUND OF THE INVENTION

### Field of the Invention

The present invention relates to a component including a joining portion in which different types of metal are joined with each other, and to a method of manufacturing the component.

### Description of the Related Art

In recent years, an industrial product and components of the product may be required to have various functions including rigidity, strength, sliding property, shielding electromagnetic wave, reflecting electromagnetic wave, transmitting heat, transmitting vibration, improving quality of external appearance, shock absorption, and lightweight property. For achieving such functions, the product or the components of the products are manufactured by performing additive manufacturing. In the additive manufacturing, on a member made of one type of metal, a member made of different type of metal is formed.

Japanese Patent Application Publication No. 2019-152859 proposes a technique for reducing the size and weight of a component. In this technique, the base body of the component is made of a metal having low specific gravity, and one portion of the component is formed on the base body through the additive manufacturing. In addition, the component is colored through coating or alumite treatment.

Japanese Patent Application Publication No. H06-10919 proposes a technique for forming a pipe joint between a stainless-steel member and a metal member made of a metal different from stainless steel and having a galvanic potential different from that of the stainless-steel member. The pipe joint is formed by performing friction welding on the stainless-steel member and the metal member. In this technique, when the pipe joint is formed, a corrosion-resistant chemical coating film is formed on a surface of the metal member on the outer side of the pipe joint, and then, a coating film is formed on a surface of the joining portion on the outer side of the pipe joint.

Japanese Patent Application Publication No. 2005-350733 proposes a technique for preventing the galvanic corrosion in a configuration in which one member and another member, made of different metal materials, are disposed in contact with each other. In this technique, the contact portion between the members made of different metal materials is covered with a coating film made of fluorine-based polymer.

However, if a conventionally proposed technique is used for a component, such as a lens-barrel component or a mirror holding component of a camera, that is required to have lightweight property and that includes a sliding portion that slides on another component, a problem may occur.

For example, in the technique disclosed in Japanese Patent Application Publication No. 2019-152859, defects such as holes are easily formed in a surface treatment layer of the joining portion in which different types of metal are joined with each other. As a result, an electrolyte may enter the joining portion through the holes, and cause the galvanic corrosion to proceed.

In addition, the technique disclosed in Japanese Patent Application Publication No. H06-10919 is used for the friction welding performed on a heavy stainless-steel member and a metal member, which is made of a metal different from stainless steel. Thus, the technique has not been studied for the component required to have lightweight property and including a sliding portion that slides on another component. Specifically, the technique has not been studied for a case where metal members having lightweight property and made of different types of metal other than stainless steel are joined with each other, and where a metal member suitable for the sliding portion is additionally manufactured. In addition, in the technique disclosed in Japanese Patent Application Publication No. H06-10919, the coating film is not formed on a surface of the joining portion on the inner side of the pipe joint. Thus, if the technique is used for a lens-barrel component, an electrolyte may enter the joining portion from the inner surface of the lens-barrel component, and cause the galvanic corrosion to proceed.

In addition, in the technique disclosed in Japanese Patent Application Publication No. 2005-350733, it is recommended that the thickness of the coating film be equal to or larger than 100 μm. However, since the coating film having such a thickness is easily deformed when pushed by a load, the shape accuracy of the coating film easily deteriorates. Thus, the coating film is not suitable for a portion (and its surroundings) that is in contact with or slides on another component.

Thus, the component, such as a lens-barrel component or a mirror holding component of a camera, that is required to have lightweight property and that includes a sliding portion that slides on another component is desired to include a joining portion, in which different types of metal having lightweight property are joined with each other, and to have the excellent shape accuracy, wear resistance, and corrosion resistance.

### SUMMARY OF THE INVENTION

According to a first aspect of the present invention, a component includes a magnesium alloy portion and an aluminum alloy portion. The magnesium alloy portion and the aluminum alloy portion are joined with each other via a joining portion. The aluminum alloy portion, the joining portion, and the magnesium alloy portion are covered with a chromium compound film.

According to a second aspect of the present invention, a method of manufacturing a component, includes forming an aluminum alloy portion that is joined with a magnesium alloy portion, by performing additive manufacturing on the magnesium alloy portion, and covering the aluminum alloy portion, a joining portion between the aluminum alloy portion and the magnesium alloy portion, and the magnesium alloy portion, with a chromium compound film.

According to a third aspect of the present invention, a component includes a base portion made of a first alloy and a sliding portion made of a second alloy whose specific gravity and hardness are higher than those of the first alloy. The base portion and the sliding portion are joined with each other via a joining portion. A surface of the sliding portion, a surface of the joining portion, and a surface of at least one portion of the base portion adjacent to the joining portion are covered with a chromium compound film. The chromium compound film is covered with a resin film that contains fluorine-based solid lubricant.

Further features of the present invention will become apparent from the following description of exemplary embodiments with reference to the attached drawings.

### BRIEF DESCRIPTION OF THE DRAWINGS

FIG. 1 is a partial cross-sectional view of a component of a first embodiment.

FIG. 2 is a perspective view of an external appearance of a guide barrel 21 of a second embodiment.

FIG. 3 is a schematic partial cross-sectional view obtained by cutting a translating cam 22 and its vicinity along a cutting line CS illustrated in FIG. 2.

FIG. 4 is a schematic diagram for illustrating an interchangeable-lens camera system of a fourth embodiment.

### DESCRIPTION OF THE EMBODIMENTS

Next, a component of an embodiment of the present invention will be described with reference to the accompanying drawings.

Note that in the drawings referred to in the following embodiments and examples, an element given an identical reference numeral has an identical function, unless otherwise specified.

### First Embodiment

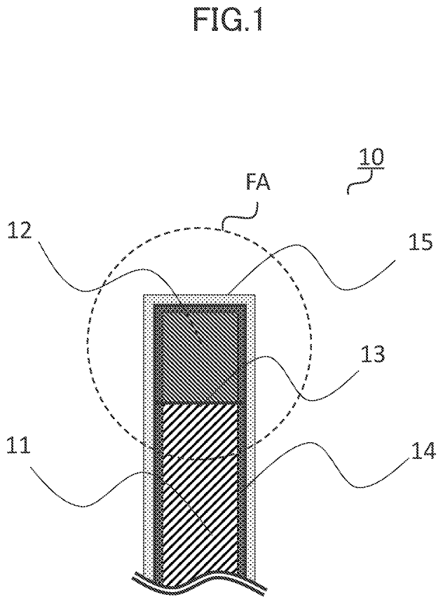

FIG. 1 is a partial cross-sectional view of a component of a first embodiment of the present invention. A component 10 of the first embodiment includes a base body in which a magnesium alloy portion 11 and an aluminum alloy portion 12 are joined with each other via a joining portion 13. A main structural portion of the base body of the component 10 is made of magnesium alloy having low specific gravity, for reducing the weight of the component 10. In addition, a portion of the base body of the component 10 that slides on another component is made of aluminum alloy having high wear resistance and lightweight property, which is similar to that of the magnesium alloy.

The magnesium alloy portion 11 and the aluminum alloy portion 12 are joined with each other by using a buildup shape-forming technique (so-called additive manufacturing) that performs fusion joining. For example, an additive manufacturing technique, such as the laser metal deposition (LIVID) or the wire-arc-additive-manufacturing (WAAM), is suitably used. In the LIVID, a workpiece is irradiated with a laser beam, and metal powder is injected onto the irradiation area. The metal powder is melted by the laser beam, and in such a manner, the buildup shape forming is performed. In the WAAM, the buildup shape forming is performed by using a method such as the tungsten inert gas (TIG) welding or the cold metal transfer (CMT) welding.

On a surface of the base body, a chromium compound film 14 is formed; and on a surface of the chromium compound film 14, a resin film 15 that contains fluorine-based solid lubricant is formed. The double coating film is formed so as to cover at least an area FA of the base body. The area FA includes the aluminum alloy portion 12, the joining portion 13, and a portion of the magnesium alloy portion 11 that is in contact with the joining portion 13. That is, the above-described double coating film is formed on a surface region including the whole surface of the aluminum alloy portion 12, the whole surface of the joining portion 13, and at least a part of the magnesium ally portion 11 adjacent to the joining portion 13.

The component of the present embodiment includes the coating film; and the outermost surface of the aluminum alloy portion 12, which slides on another component, is covered with the resin film 15 that contains fluorine-based solid lubricant. Thus, since the aluminum alloy portion 12 that slides on another component has low friction coefficient, the wear resistance of the aluminum alloy portion 12 increases. Note that the thickness of the resin film 15 is preferably smaller than 30 μm for preventing the deformation of the sliding surface and its vicinity caused when the sliding surface is pushed.

As described above, the surface region including the whole surface of the aluminum alloy portion 12, the whole surface of the joining portion 13, and at least a part of the magnesium ally portion 11 adjacent to the joining portion 13 is covered with the chromium compound film 14 and the resin film 15. Thus, since the aluminum alloy portion 12, the joining portion 13, and the at least one portion of the magnesium alloy portion 11 are protected from moisture in the air, the corrosion resistance of the component increases. That is, since the joining portion in which different types of metal are joined with each other, and its surrounding portions are covered with the chromium compound film 14 and the resin film 15, and isolated from moisture in the air, the galvanic corrosion can be suppressed.

Preferably, the chromium compound film 14 is a chemical coating film formed through a trivalent chromate treatment, for example. In addition, the resin film 15 is preferably a coating film (resin film) formed by applying epoxy-based resin coating material that contains fluorine-based solid lubricant, onto the chromium compound film 14.

Note that the above-described double coating film may be formed not only on the area FA, but also on the whole of the base body. If the double coating film is formed on the whole of the base body, the manufacturing process may be more simplified than the manufacturing process in which the double coating film is selectively formed only on the area FA. In this case, since the whole surface of the base body is isolated from moisture, the corrosion resistance of the whole of the component increases.

As described above, the component of the first embodiment includes a base portion made of a first alloy, and a sliding portion made of a second alloy whose specific gravity and hardness are higher than those of the first alloy. In addition, the base portion and the sliding portion are joined with each other via the joining portion; the surface of the sliding portion, the surface of the joining portion, and at least a part of the base portion adjacent to the joining portion are covered with the chromium compound film 14; and the chromium compound film 14 is covered with the resin film 15 that contains fluorine-based solid lubricant.

### Second Embodiment

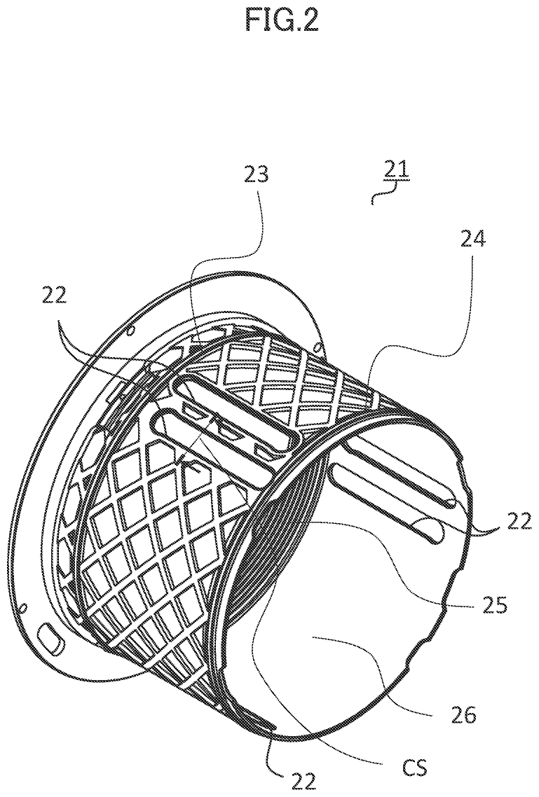

In a second embodiment of the present invention, a guide barrel will be described. The guide barrel is a component of a lens barrel of a camera. FIG. 2 is a perspective view of an external appearance of a guide barrel 21 of the second embodiment.

The base body of the guide barrel 21 is cylindrical, and is formed such that different types of metal are joined with each other through additive manufacturing. For reducing the weight of the component, a housing portion of the component that needs strength, rigidity, and light shielding property is made of a magnesium alloy AZ91 (composition: Mg-9% Al-1% Zn), which is a metal with low density. In addition, a sliding portion of the component that slides on another component, and surrounding portions of the sliding portion are made of an aluminum alloy A4043 (composition: Al-5% Si), which is relatively light in weight and has higher wear resistance than the magnesium alloy AZ91.

The guide barrel 21 includes projection portions 23 and 24 formed along the whole circumference of the guide barrel 21; and the projection portions 23 and 24 engage with a cam barrel (i.e., another component that is not illustrated), which is disposed outside the guide barrel 21. In addition, translating cams 22 are formed in the side surface of a cylindrical portion of the guide barrel 21, at intervals of 120° in the circumferential direction. The translating cams 22 engage with a focusing lens (not illustrated).

Thus, since the projection portion 23, the projection portion 24, and the translating cams 22 slide on other components, the projection portion 23, the projection portion 24, the translating cams 22, and their surrounding portions are made of aluminum alloy; and the basic structure portion other than the above-described portions is made of magnesium alloy. The magnesium alloy portion and the aluminum alloy portion are joined with each other via a joining portion, which is made of an intermetallic compound (e.g., Al3Mg2 or Al12Mg17) formed in the fusion joining. On the surface of the guide barrel 21, the surface including the whole surface of the aluminum alloy portion, the whole surface of the joining portion, and at least a part of the magnesium alloy portion adjacent to the joining portion, the corrosion-resistant chemical coating film and the resin film that contains fluorine-based solid lubricant are formed.

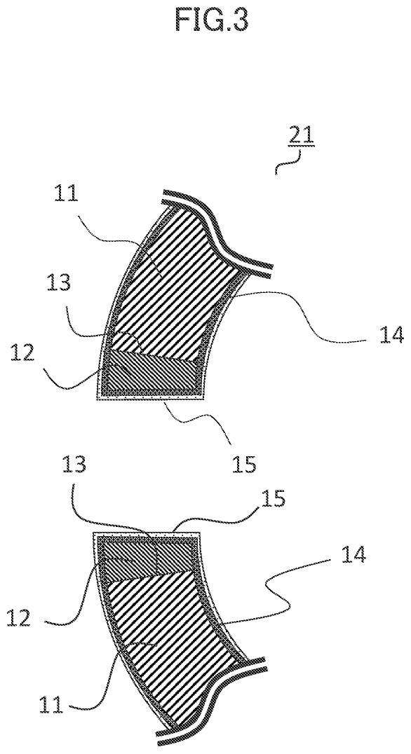

FIG. 3 is a schematic partial cross-sectional view obtained by cutting a translating cam 22 and its vicinity along a cutting line CS illustrated in FIG. 2. The magnesium alloy portion 11 is the basic structure portion of the housing, and is made of magnesium alloy. The translating cam 22 is made of aluminum alloy. The aluminum alloy portion 12 is joined with the magnesium alloy portion 11 via the joining portion 13. On the surface of the guide barrel 21, the chromium compound film 14 (i.e., chemically-formed coating film) is formed through a trivalent chromate treatment. In addition, the resin film 15 is formed on the chromium compound film 14 so as to cover the chromium compound film 14. The resin film 15 is made of a black epoxy-based resin coating material that contains fluorine-based solid lubricant.

In the guide barrel 21 of the present embodiment, the surface of the magnesium alloy portion and the aluminum alloy portion, which is easily corroded, is covered with the chromium compound film (chemical coating film) 14 and the resin film 15. Thus, the surface is protected from moisture in the air, and the corrosion resistance of the surface increases. In addition, the joining portion between the magnesium alloy portion and the aluminum alloy portion and its vicinity are also covered with the chromium compound film (chemical coating film) 14 and the resin film 15. Thus, the moisture in the air does not contact the joining portion, so that the galvanic corrosion can be prevented. In addition, the sliding surface of the translating cams 22 are covered with the resin film 15, which is made of resin coating material that contains fluorine-based solid lubricant. Thus, since the sliding surface that slides on another component has low friction coefficient, the wear resistance of the sliding surface increases.

For example, the resin coating material that contains fluorine-based solid lubricant may be a black coating material that contains black pigment. The use of the black coating material can suppress the light from being reflected from inner surfaces 25 and 26 of the guide barrel 21, preventing the occurrence of stray light. Note that the thickness of the black resin film 15 that contains fluorine-based solid lubricant is preferably in a range of 12±5 that is, the thickness is preferably equal to or larger than 7μm and equal to or smaller than 17 μm. In this case, the sliding portion and its vicinity are prevented from being deformed when pushed, so that the deterioration in shape accuracy of the guide barrel 21 is prevented.

The guide barrel 21 of the present embodiment is light in weight, and has high corrosion resistance performance and excellent driving property. In addition, by using the lens-barrel component of the present embodiment, a compact and light lens unit, and an image pickup apparatus, such as a digital camera, that includes the lens unit can be made.

As described above, the present invention is suitably applied to a cam barrel that is used as an outer barrel of a focus unit included in a lens barrel. However, the present invention may be applied to another component that constitutes another lens barrel, such as a fixed barrel. In addition, the present disclosure may be applied not only to a component of a focus unit, but also to a component of a zoom unit used for operating a zoom optical system.

### Third Embodiment

In the above-described second embodiment, the present invention is applied, as an example, to a component of a lens barrel of a camera. However, in the field of optical components, the application of the present invention is not limited to the application to the component of the lens barrel. For example, the present invention may be applied to an optical component that is required to have lightweight property, and that includes a sliding portion that slides on another component.

For example, a movable component, such as an instant return mirror (movable mirror) of a single-lens reflex camera, and a holder that holds the movable component are components that are required to have lightweight property, and that include a sliding portion that slides on another component. Thus, the present invention can be applied to these components. Also in such a component, a main structural portion of the base body is made of magnesium alloy having low specific gravity, for reducing the weight of the component. In addition, a portion of the base body of the component that slides on another component is made of aluminum alloy having high wear resistance and lightweight property, which is similar to that of the magnesium alloy.

The double coating film described in the first or the second embodiment is formed on the whole surface of the aluminum alloy portion 12, the whole surface of the joining portion 13, and at least one portion of the magnesium ally portion 11 adjacent to the joining portion 13.

Preferably, the chromium compound film of the double coating film, which is formed on the base body side, is a chemical coating film formed through a trivalent chromate treatment. In addition, the resin film of the double coating film, which is formed on the outermost surface side of the component, is a resin film formed by applying an epoxy-based resin coating material that contains fluorine-based solid lubricant, onto the chromium compound film.

The aluminum alloy portion, which slides on another component, is covered with the resin film that contains fluorine-based solid lubricant. Thus, since the aluminum alloy portion that slides on another component has low friction coefficient, the wear resistance of the aluminum alloy portion increases. Note that the thickness of the resin film is preferably smaller than 30 μm for preventing the deformation of the sliding surface and its vicinity caused when the sliding surface is pushed.

In a case where the double coating film is formed on a portion that is required to have less reflectivity, the resin coating material that contains fluorine-based solid lubricant may be a black coating material that contains black pigment. The use of the black coating material can reduce the reflectivity of the portion. In a case where the double coating film is formed on a portion that is required to keep the reflectivity, or on a portion that is required to have a certain color, the resin coating material that contains fluorine-based solid lubricant may be a coating material that contains a corresponding pigment.

### Fourth Embodiment

In a fourth embodiment, an interchangeable-lens camera system will be described. The interchangeable-lens camera system includes an interchangeable lens and a camera body. The interchangeable lens includes a lens-barrel component to which the present invention has been applied, and the camera body contains a component to which the present invention has also been applied.

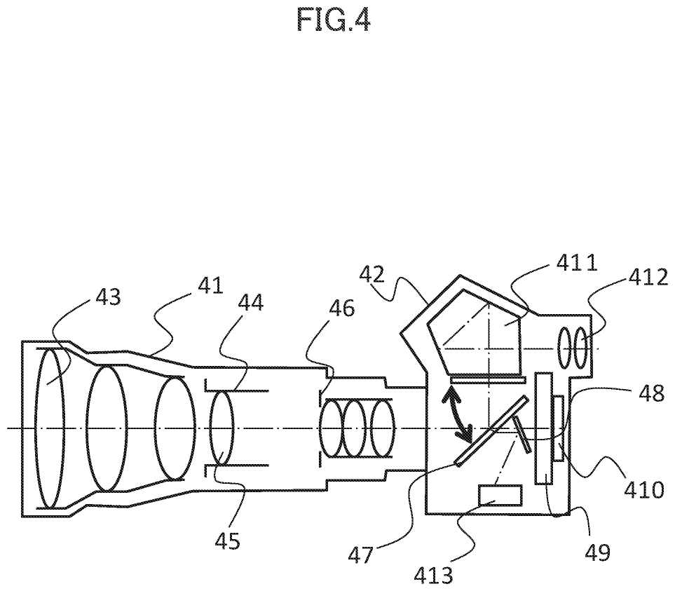

FIG. 4 is a schematic diagram illustrating a state in which a taking lens (interchangeable lens) 41 is attached to a camera body 42 of an interchangeable lens camera. The taking lens 41 includes a lens-barrel component 44 to which the present invention has been applied, and the camera body 42 includes an instant return mirror to which the present invention has also been applied.

The light from a subject is introduced into the camera body 42 through optical lenses, such as lenses 43 and 45 of the taking lens 41, and thereby a picture of the subject is taken. Before the picture is taken, part of the light from the subject is reflected from a main mirror 47, travels through a prism 411 and a viewing lens 412, and forms an image of the subject. Thus, a person that will take the picture can view the image of the subject.

The main mirror 47 of the instant return mirror is a half mirror. The light having passed through the main mirror 47 is reflected by a submirror 48 toward an autofocus (AF) unit 413. The reflected light is used for measuring a distance, for example. When a picture is taken, the main mirror 47 and the submirror 48 are moved out of the optical path by a driving mechanism (not illustrated), and a shutter 49 is opened. With these operations, the light having passed through the taking lens 41 forms an image on an image pickup device 410. The brightness and the focal depth, used when a picture is taken, can be changed by changing the aperture area of a diaphragm 46.

Note that the single-lens reflex camera illustrated in FIG. 4 may be another camera that records an image on a recording medium, such as a silver halide film, instead of the image pickup device 410. Also in this case, a mirror holder of the present embodiment can have the same configuration. In addition, although the taking lens 41 is an interchangeable lens, in the present embodiment, that can be detachably attached to the camera body 42, the taking lens 41 may be fixed to the camera body 42.

The main mirror 47 is constituted by a main-mirror holder and a mirror. The mirror is attached to the main-mirror holder by bonding or the like; and is supported by the main-mirror holder. FIG. 4 illustrates a state in which no picture is taken. In this state, the main mirror 47 reflects the observation light toward the viewing lens 412. When a picture is taken, the main mirror 47 is swung to a horizontal position of FIG. 4, as illustrated by an arrow, by a driving mechanism (not illustrated) in synchronization with the opening of the shutter 49. When the main mirror 47 is swung to the horizontal position, the submirror 48 is folded so as to substantially flush with the main mirror 47. The main mirror 47 is swung for moving out of the optical path (of the light for taking a picture), and for blocking an optical path formed between the main mirror 47 and the viewing lens 412. The main mirror 47 blocks the optical path for preventing a ghost image that is formed by the light from the viewing lens 412. After a picture is taken, that is, after the necessary exposure is performed on the image pickup device 410, the shutter 49 is closed. In synchronization with this, the main mirror 47 is quickly returned to the position illustrated in FIG. 4, for causing a view finder to display an image of a subject.

Thus, the main mirror 47 is referred to also as an instant return mirror, and includes a sliding portion. The main-mirror holder is part of the main mirror 47, and includes a base portion and a sliding portion. The base portion is made of magnesium alloy whose density is lower than that of the sliding portion, and the sliding portion is made of aluminum alloy whose wear resistance is higher than that of the magnesium alloy. In addition, the surface of the magnesium alloy portion and the aluminum alloy portion, which is easily corroded, is covered with the chromium compound chemical film and the resin-material coating film. Thus, the surface is protected from moisture in the air. The main mirror 47 made in this manner and other components illustrated in FIG. 4 are assembled into an interchangeable lens camera of the present embodiment.

### EXAMPLES

### Example 1

Hereinafter, examples will be described. First, a disk-shaped piece made of AZ91 (composition: Mg-9% Al-1% Zn) and having a diameter (Φ) of 60 mm and a thickness (t) of 5 mm was prepared as a base portion of a component. The piece was made through casting. Then, a portion of the piece that slides on another component was joined with another piece made of A4043 (composition: Al-5% Si), through the tungsten inert gas (TIG) welding. The surface of the piece, which had been joined to the piece made of AZ91 and which was made of A4043, was smoothened, as appropriate, through a removal process, so that the piece made of A4043 was shaped suitably into a sliding portion.

Then, the chemically-formed coating film is formed, through a trivalent chromate treatment, on the whole surface of the component, the component including the base portion to which the piece made of A4043 has been joined. After that, the epoxy-based resin coating material that contains fluorine-based solid lubricant was applied onto the chromium compound film, which was formed on the whole surface of the component, by using a spray method. The thickness of the resin coating film was 12 μm.

### Example 2

As Example 2, a component was made by joining the base portion made of AZ91, with the piece made of A4043, as in Example 1. However, neither the chemical coating film formed through the trivalent chromate treatment nor the epoxy-based resin coating film that contains fluorine-based solid lubricant were not formed on the component of Example 2.

### Example 3

As Example 3, a component was made by joining the base portion made of AZ91, with the piece made of A4043, as in Example 1. In this case, the chemical coating film formed through the trivalent chromate treatment under the same condition as that of Example 1 was formed on the component of Example 3, but the epoxy-based resin coating film that contains fluorine-based solid lubricant was not formed.

For checking the corrosion resistance, a high-temperature and high-humidity test was performed on the components of Examples 1, 2 and 3, which were made as described above, and in which different types of metal are joined with each other. The components were left for a long time, in a high-temperature and high-humidity environment with a temperature of 55° C. and a humidity of 95%. After that, the surfaces of the components were observed through a tool microscope. As a result, it was observed that the surface of the component of Example 1 was not corroded, exhibiting good corrosion resistance performance. In contrast, it was observed that an oxide had occurred on the surfaces of the components of Examples 2 and 3, and that the surfaces were corroded.

In addition, the wear resistance of the sliding portions of the components was examined by measuring the friction coefficient of the sliding portions, by performing a ball-on-disk test. In the ball-on-disk test, the radius of rotation of each component was 28 cm; and each component was rotated for 72 hours at a rotational speed of 60 rpm, in a state where the component was applied with a pressure of 50 g. As a result, in Example 1, the friction coefficient μ was 0.08, and was stable in the test period. As to the surface of the sliding portion observed through the tool microscope, the coating film had no concave portions and was not worn, exhibiting good wear resistance. In contrast, the friction coefficient μ was 0.21 in Example 2, and 0.23 in Example 3, which were relatively large values. As to the surface of the sliding portion observed through the tool microscope, a mark of sliding was observed on the surface of the piece made of A4043, and on the surface of the chemically-formed coating film.

As described above, the component of Example 1 was superior to the components of Examples 2 and 3, in the corrosion resistance and the sliding property of the sliding portion.

Note that the present invention is not limited to the above-described embodiments and examples, and can be variously modified within a technical concept of the present invention.

That is, the present invention can be applied to an apparatus required to have lightweight property and including a movable portion, and to a component of the apparatus. For example, the present disclosure can be applied not only to the interchangeable-lens single-lens reflex camera described, as an example, in the fourth embodiment, but also to various optical apparatuses, such as an interchangeable-lens mirrorless camera system and a camera that includes a non-interchangeable lens and an optical zoom function. The camera may include a mechanical or electronic shutter, and may have a communication function.

In addition, the present invention can also be applied to a component of a portable communication apparatus, which is required to have lightweight property and which includes a movable portion or a sliding portion. For example, the present disclosure can be applied to a movable component of a foldable smartphone, a component of a movable antenna of a cellular phone, or a component of a cellular phone that includes a camera having an optical zoom function.

In addition, the present invention can also be applied to a component of a moving device, which is required to have lightweight property and which includes a movable portion or a sliding portion. For example, the present disclosure can be applied to a movable component of a so-called drone (super-small airplane), or a component of a camera used for taking aerial photographs.

Various apparatuses including a component of an embodiment of the present invention are also included in an embodiment of the present invention. Examples of the various apparatuses include an optical apparatus such as an interchangeable lens, an image-pickup apparatus such as a camera, a communication apparatus such as a portable communication device, a transportation apparatus such as a drone, a medical apparatus such as a diagnostic imaging apparatus, an industrial apparatus such as a robot, and an office apparatus such as a printer. Each of the various apparatuses may include optical components, such as a lens, a mirror, a filter, a shutter, a display, and an image sensor, and electronic components such as semiconductor devices, in addition to the component including the magnesium alloy portion and the aluminum alloy portion, and a component that slides on the aluminum alloy portion.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-208127, filed Dec. 16, 2020, which is hereby incorporated by reference herein in its entirety.

What is claimed is:

1. A component comprising:
a magnesium alloy portion; and
an aluminum alloy portion,
wherein the magnesium alloy portion and the aluminum alloy portion are joined with each other via a joining portion, and
wherein the aluminum alloy portion, the joining portion, and the magnesium alloy portion are covered with a chromium compound film.

2. The component according to claim 1, wherein the chromium compound film is covered with a resin film.

3. The component according to claim 2, wherein the resin film contains fluorine-based solid lubricant.

4. The component according to claim 2, wherein a thickness of the resin film is smaller than 30 μm.

5. The component according to claim 4, wherein the thickness of the resin film is equal to or larger than 7 μm and equal to or smaller than 17 μm.

6. The component according to claim 2, wherein the resin film is a coating film formed by applying an epoxy-based resin coating material that contains fluorine-based solid lubricant.

7. The component according to claim 2, wherein the resin film is a black film.

8. The component according to claim 2, wherein the magnesium alloy portion is cylindrical, and wherein the chromium compound film and the resin film are formed also on an inner surface of the magnesium alloy portion.

9. The component according to claim 1, wherein the chromium compound film is a chemical coating film formed through a trivalent chromate treatment.

10. An apparatus comprising:
the component according to claim 1; and
another component.

11. The apparatus according to claim 10, wherein the aluminum alloy portion is formed in a portion of the component that slides on the other component.

12. The apparatus according to claim 10, further comprising an optical component.

13. A method of manufacturing a component, comprising:
forming an aluminum alloy portion that is joined with a magnesium alloy portion, by performing additive manufacturing on the magnesium alloy portion; and
covering the aluminum alloy portion, a joining portion between the aluminum alloy portion and the magnesium alloy portion, and the magnesium alloy portion, with a chromium compound film.

14. The method according to claim 13, further comprising:
covering the chromium compound film with a resin film that contains fluorine-based solid lubricant.

15. The method according to claim 14, wherein a thickness of the resin film is smaller than 30 μm.

16. The method according to claim 15, wherein the thickness of the resin film is equal to or larger than 7 μm and equal to or smaller than 17 μm.

17. The method according to claim 14, comprising:
forming the resin film by applying an epoxy-based resin coating material that contains fluorine-based solid lubricant.

18. The method according to claim 14, comprising:
forming the resin film by applying a black epoxy-based resin coating material.

19. The method according to claim 13, wherein the additive manufacturing is a buildup shape-forming technique that performs fusion joining.

20. The method according to claim 13, comprising:
forming the chromium compound film through a trivalent chromate treatment.

21. A component comprising:
a base portion made of a first alloy; and
a sliding portion made of a second alloy whose specific gravity and hardness are higher than those of the first alloy,
wherein the base portion and the sliding portion are joined with each other via a joining portion,
wherein a surface of the sliding portion, a surface of the joining portion, and a surface of at least one portion of the base portion adjacent to the joining portion are covered with a chromium compound film, and
wherein the chromium compound film is covered with a resin film that contains fluorine-based solid lubricant.
